(19) United States
(12) Patent Application Publication
(10) Pub. No.: US 2019/0118295 A1
(43) Pub. Date: Apr. 25, 2019

(54) Glowing Part And Tooling In Simultaneous Laser Plastics Welding

(71) Applicant: Branson Ultrasonics Corporation, Danbury, CT (US)

(72) Inventors: Scott CALDWELL, New Milford, CT (US); Christopher ALMONTE, Rochester, NY (US)

(73) Assignee: Branson Ultrasonics Corporation, Danbury, CT (US)

(21) Appl. No.: 16/146,227

(22) Filed: Sep. 28, 2018

Related U.S. Application Data
(60) Provisional application No. 62/574,823, filed on Oct. 20, 2017.

(51) Int. Cl. B23K 26/21; G01J 1/42; G01J 1/04; B23K 26/00; B23K 26/70; B23K 26/06; B29C 65/16; B29C 65/00

(52) U.S. Cl. CPC B23K 26/21; G01J 1/4257; G01J 1/0488; B23K 26/0006; G02B 5/20; B23K 26/0626; B29C 65/16; B29C 66/95; B23K 26/705

(57) ABSTRACT

Sensors incorporated within a laser bank detect light emitted by light sources that is directed into and travels through a delivery end of an associated laser delivery optical fiber. The light sources may be positioned between downstream of the delivery end of the associated laser delivery optical fiber and a lower tooling. In some embodiments, the light source is incorporated within a waveguide. In other embodiments, the light source is positioned within a dummy part.

### CROSS-REFERENCE TO RELATED APPLICATIONS

This application claims the benefit of U.S. Provisional Application No. 62/574,823, filed on Oct. 20, 2017. The entire disclosure of the above application is incorporated herein by reference.

### FIELD

The present disclosure relates to plastics welding and, more particularly, relates to assessing optical fibers in direct delivery welding and simultaneous laser welding applications.

### BACKGROUND

This section provides background information related to the present disclosure which is not necessarily prior art.

Laser welding is commonly used to join plastic or resinous parts, such as thermoplastic parts, at a welding zone.

There are many different laser welding technologies. One useful technology is simultaneous through transmissive infrared welding, referred to herein as STTIr. In STTIr, the full weld path or area (referred to herein as the weld path) is simultaneously exposed to laser radiation, such as through a coordinated alignment of a plurality of laser light sources, such as laser diodes. An example of STTIr is described in U.S. Pat. No. 6,528,755 for “Laser Light Guide for Laser Welding,” the entire disclosure of which is incorporated herein by reference. In STTIr, the laser radiation is typically transmitted from one or more laser sources to the parts being welded through one or more optical waveguides which conform to the contours of the parts' surfaces being joined along the weld path. To ensure an accurate and comprehensive weld, the gap between any waveguide and the workpiece closest to the waveguide is kept as small as possible. Correspondingly, to improve efficiency, the gap between the delivery end of the fiber bundle and the waveguide is also kept as small as possible. There is a corresponding need to monitor the degradation of optical fibers over multiple weld cycles while keeping the aforementioned gaps as small as possible.

### SUMMARY

This section provides a general summary of the disclosure, and is not a comprehensive disclosure of its full scope or all of its features.

The present technology provides a method for sensing the output of light traveling through at least a laser delivery optical fiber to determine the integrity of a laser delivery bundle in a simultaneous laser welding system. The simultaneous laser welding system is comprised of a laser source that directs a laser from a laser bank from the input ends through to the delivery ends of a plurality of laser delivery bundles, wherein each laser delivery bundle is comprised of at least a laser delivery optical fiber for welding a plurality of work pieces. The method includes directing light emitted by a light source positioned downstream of a delivery end of the laser delivery optical fiber through said delivery end of said laser delivery optical fiber used in the simultaneous laser welding system. A sensor senses the light after the light is directed from and has traveled through the delivery end to an input end of the associated laser delivery optical fiber, and the output of light sensed by the sensor can be used to determine the integrity of the laser delivery bundle. In other embodiments, directing the light is conducted by positioning the light source between the delivery end of the associated laser delivery optical end and the plurality of work pieces. In other such other embodiments, the method further comprises covering the sensor with a chromatic bandpass filter. In yet other such other embodiments, the method further comprises emitting light via the light source at a separate time interval from a weld cycle. In further embodiments, the directing the light is conducted by positioning the light source within a dummy part, wherein the dummy part is positioned where the plurality of work pieces typically reside during a weld cycle. In even further embodiments, the sensor outputs the sensed light to a controller. In other such even further embodiments, the method further comprises determining via the controller whether the sensor sensed a satisfactory amount of light emitted by the light source and alerting a user via the controller when said sensor senses that said light emitted from said light source is satisfactory. In yet other such even further embodiments, the method further comprises welding via the simultaneous laser welding system the plurality of work pieces with laser light and adjusting the laser light intensity via the controller when the sensor senses that the light emitted from the light source is unsatisfactory.

The present technology also provides a simultaneous laser welding apparatus. The simultaneous laser welding apparatus includes a laser bank for outputting from a laser source laser light through a plurality of laser delivery bundles through a waveguide to a plurality of work pieces to be welded, and each laser delivery bundle is comprised of at least a laser delivery optical fiber. A light source is positioned downstream of a delivery end of the laser delivery optical fiber, and the light source is positioned to direct light through the delivery end of the laser delivery optical fiber. A sensor is positioned within the laser bank for sensing light directed from the light source through the laser delivery optical fiber. The sensor relays the sensed light output to a controller. The controller uses the sensed light output to determine the integrity of the laser delivery bundles may be assessed. In other embodiments, a chromatic bandpass filter covers the sensor. In yet other embodiments, the light source is positioned between the delivery end of the associated laser delivery optical fiber and the plurality of work pieces. In other such yet other embodiments, the light source is positioned within the waveguide. In further embodiments, the light source is positioned within a dummy part and the dummy part is positioned where the plurality of work pieces typically reside during a weld cycle. In even further embodiments, the controller is configured to determine whether the sensor sensed a satisfactory amount of light emitted by the light source and alert a user when said sensor senses that said light emitted from said light source is unsatisfactory. In yet further embodiments, the controller is configured to adjust the laser light intensity when the sensor senses that the light emitted by the light source is unsatisfactory.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view illustrating a prior art laser welder;

FIG. 2 is a schematic view illustrating an embodiment according to the present disclosure;

FIG. 3 is an enlarged schematic view illustrating positioning of multiple sensors according to the embodiments above;

FIG. 4 is an enlarged schematic view illustrating positioning of a sensor according to the embodiments above;

FIG. 5 is a schematic view illustrating another embodiment according to the present disclosure;

FIG. 6 is a flow chart of control logic for a control routine for determining whether a laser delivery bundle is delivering satisfactory laser light intensity according to an embodiment of the present disclosure; and

FIG. 7 is a flow chart of control logic for a control routine for determining whether a laser delivery bundle is delivering satisfactory laser light intensity according to another embodiment of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

It should be understood for any recitation of a method, composition, device, or system that “comprises” certain steps, ingredients, or features, that in certain alternative variations, it is also contemplated that such a method, composition, device, or system may also “consist essentially of” the enumerated steps, ingredients, or features, so that any other steps, ingredients, or features that would materially alter the basic and novel characteristics of the invention are excluded therefrom.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. If, for some reason, the imprecision provided by “about” is not otherwise understood in the art with this ordinary meaning, then “about” as used herein may indicate a possible variation of up to 5% of the indicated value or 5% variance from usual methods of measurement.

As used herein, the term “composition” refers broadly to a substance containing at least the preferred metal elements or compounds, but which optionally comprises additional substances or compounds, including additives and impurities. The term “material” also broadly refers to matter containing the preferred compounds or composition.

In addition, disclosure of ranges includes disclosure of all values and further divided ranges within the entire range, including endpoints and sub-ranges given for the ranges.

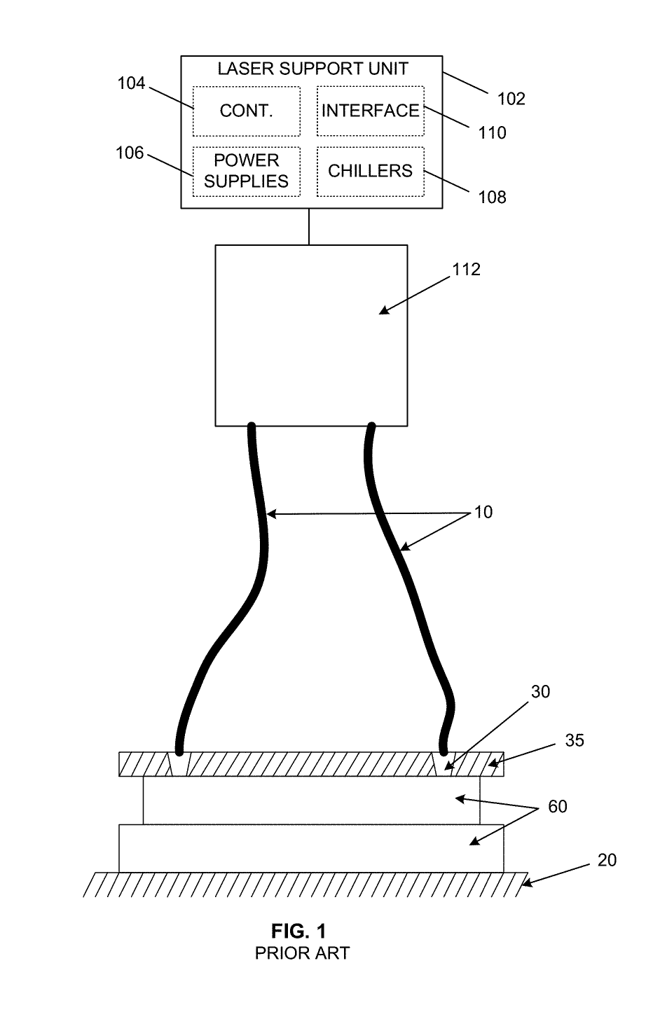

As illustrated in FIG. 1, the technology according to the present disclosure provides methods and apparatuses for use in simultaneous laser welding. Under conventional methods for simultaneous laser welding, a laser bank 112 directs laser light via a source of laser radiation through a plurality of laser delivery bundles 10. Each laser delivery bundle 10 may be further split into legs and each leg is comprised of at least a laser delivery optical fiber. If laser delivery bundle 10 is not split into legs, then each laser delivery bundle 10 is comprised of at least a laser delivery optical fiber. Each laser delivery optical fiber delivers laser light via the source of laser radiation from laser bank 112 through a waveguide 30 to a plurality of work pieces 60 to be welded together. Waveguide 30 homogenizes the laser light delivered to work pieces 60 through each laser delivery optical fiber.

Under many aspects, the embodiments described according to the present disclosure may be used as part of an STTIr laser welding system. Referring again to FIG. 1, an exemplary STTIr system includes a laser support unit 102 including one or more controllers 104, an interface 110, one or more power supplies 106, and one or more chillers 108. Laser support unit 102 is in electrical communication with associated sensors (such as sensor 70, light source sensor 80, and laser bank sensor 90, as described in more detail below). The STTIr laser welding system may also include an actuator, one or more laser banks 112, and an upper tool/waveguide assembly 35 and a lower tool 20 fixtured on a support table. Laser support unit 102 is coupled to the actuator and each laser bank 112 and provides power and cooling via power supply (or supplies) 106 and chiller (or chillers) 108 to laser banks 112 and controls the actuator and laser banks 112 via controller 104. The actuator is coupled to the upper tool/waveguide assembly and moves it to and from the lower tool under control of controller 104.

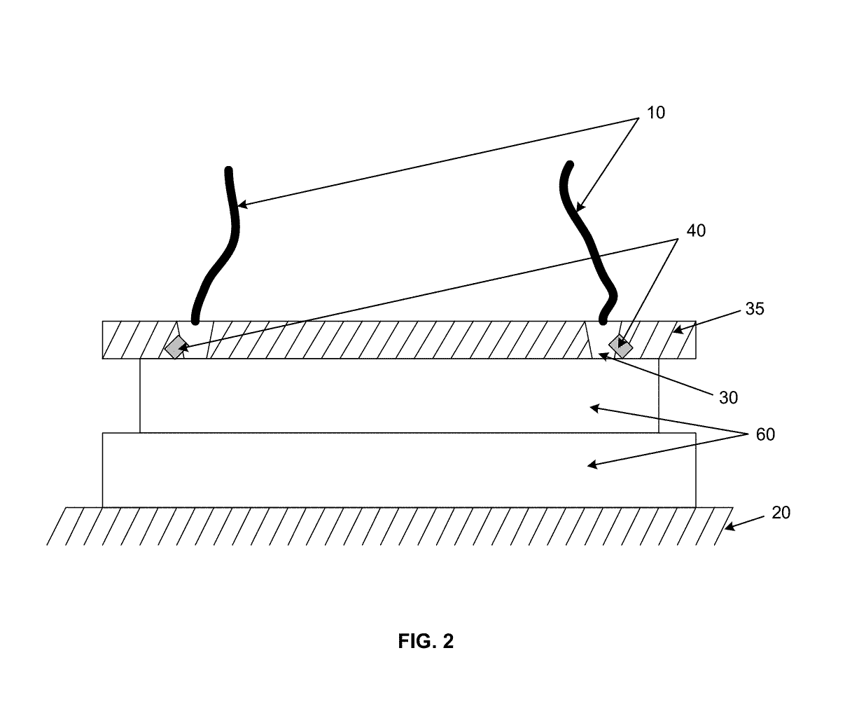

Referring to FIG. 2, and further expounding upon the simultaneous laser welder described according to FIG. 1, according to an embodiment of the present disclosure, at least a light source 40 is positioned downstream of a delivery end (i.e., the end of the laser delivery optical fiber where laser light is directed to plurality of work pieces 60 to be welded) of an associated laser delivery optical fiber. In other words, light source 40 can be positioned at any position between a delivery end of an associated laser delivery optical end and the plurality of work pieces 60. In some embodiments, light source 40 may, for example, be incorporated in waveguide tooling 35 (e.g., in waveguide 30). In each such embodiment, light source 40 is positioned so that light emitted by light source 40 passes upstream through a delivery end of an associated laser delivery optical fiber.

Appropriate light sources are any light sources capable of providing light, including luminescent light sources, such as light-emitting diodes and lasers; incandescent sources, such as halogen lamps and incandescent light bulbs; and electric discharge light sources, such as fluorescent lamps. The light sources may be positioned anywhere between downstream of a delivery end of a laser delivery optical fiber and lower tool 20 fixtured on a support table (as described in more detail below). As examples, the light sources may be incorporated within a waveguide, or incorporated within dummy parts. Notably, the light sources are positioned to direct light through a delivery end of a laser delivery optical fiber to an associated sensor.

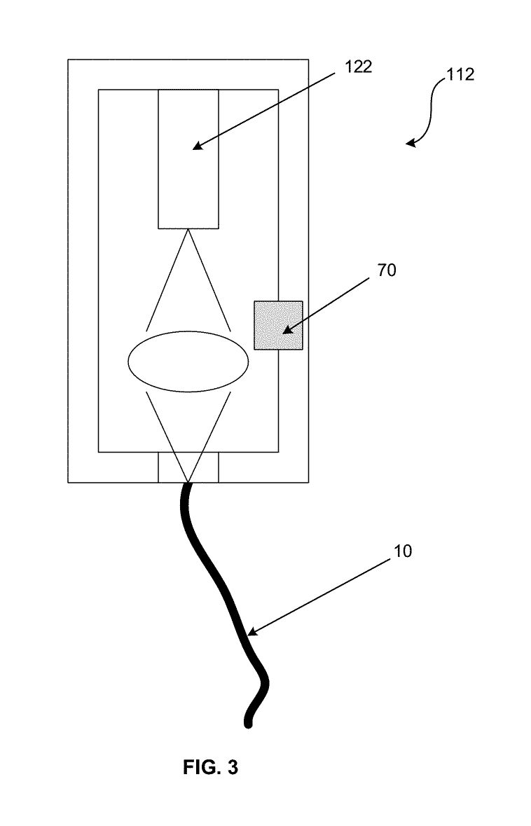

Turning now to FIG. 3, light emitted from light source 40 passing upstream through a delivery end of an associated laser delivery optical fiber is sensed by sensor 70. Sensor 70 is positioned within laser bank 112 to sense light emitted by light source 40 that has been directed from and subsequently traveled through a delivery end of the associated laser delivery optical fiber. Sensor 70 senses not only such light emitted from light source 40 but also laser light emitted from a source 122 of laser radiation. Thus, sensor 70 further senses laser light emitted from source of 122 laser radiation. Notably, a single sensor 70 may be used even where the laser light emitted from source 122 of laser radiation and the light emitted from light source 40 each consist of wavelengths that sensor 70 can detect. Thus, it is contemplated that in such an embodiment the wavelength of laser light emitted by source 122 of laser radiation may be the same or similar to the wavelength of light emitted by light source 40. Further, in such embodiments, it is contemplated that light source 40 and laser bank 112 will be operational separately from each other so that sensor 70 detects light only from one source at a given time to prevent sensor 70 from confounding each of the light signals emitted. In this manner, the integrity of the associated laser delivery optical fiber may be determined. More specifically, the intensity of light emitted by light source 40 sensed by sensor 70 correlates to the integrity of the associated laser delivery optical fiber. For example, the intensity of light emitted by light source 40 having traveled through an associated laser delivery optical fiber sensed by sensor 70 before a single weld cycle has initiated is output to a controller 104. After each weld cycle (or after a predetermined number of weld cycles), light source 40 again emits light that passes through the associated laser delivery optical fiber at a downstream end to sensor 70. The resulting intensity of light sensed by sensor 70 can then be compared to the initial intensity by controller 104 to determine whether the associated laser delivery optical fiber is yet satisfactorily delivering laser light through it.

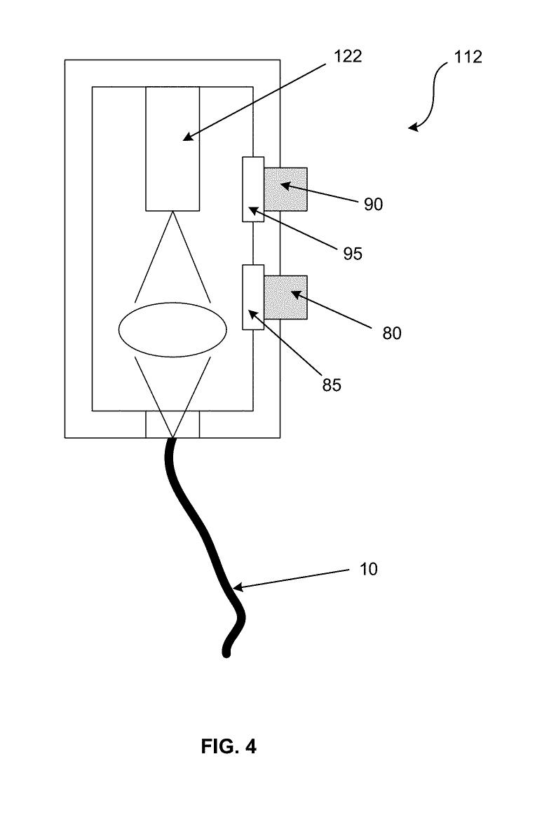

Referring to FIG. 4, light emitted from light source 40 passing upstream through a delivery end of an associated laser delivery optical fiber is sensed by light source sensor 80. Light source sensor 80 may be positioned within laser bank 112 to sense light emitted by light source 40 that has been directed from and subsequently traveled through a delivery end of the associated laser delivery optical fiber. Laser bank sensor 90, on the other hand, senses laser light emitted from source 122 of laser radiation. In such an embodiment, the wavelength of light emitted from light source 40 can be sensed by light source sensor 80 but not by laser bank sensor 90. Similarly, the wavelength of light emitted from source 122 of laser radiation cannot be sensed by light source sensor 80 but can be sensed by laser bank sensor 90. In some embodiments, light source sensor 80 and laser bank sensor 90 detect only their associated light sources by using chromatic bandpass filters so that the respective sensors are incapable of sensing wavelengths of their non-associated light sources. In other words, a first chromatic bandpass filter 85 may be integrated with or cover light source sensor 80 to prevent light source sensor 80 from sensing wavelengths emitted by source 122 of laser radiation, and a second chromatic bandpass filter 95 may be integrated with or cover laser bank sensor 90 to prevent laser bank sensor 90 from sensing wavelengths emitted by light source 40. In such embodiments, light source 40 and source 122 of laser radiation may be operational simultaneously; bifurcating operation of the light sources is not required as the light source sensor 80 and laser bank sensor 90 will not be confounded by light emitted from their non-associated light sources. That said, light source 40 need not always be in an operational state. In this manner, the integrity of the associated laser delivery optical fiber may be determined. More specifically, the intensity of light emitted by light source 40 sensed by light source sensor 80 correlates to the integrity of the associated laser delivery optical fiber. For example, the intensity of light emitted by light source 40 having traveled through an associated laser delivery optical fiber sensed by light source sensor 80 before a single weld cycle has initiated is output to a controller 104. Light source 40 may continuously emit light that passes through the associated laser delivery optical fiber at a downstream end to light source sensor 80, and the resulting intensity of light sensed by light source sensor 80 may be continuously outputted to controller 104. In alternate embodiments, light source 40 may intermittently operate during predetermined times (e.g., after a given number of weld cycles), where light emitted by light source 40 is sensed by light source sensor 80 and the resulting sensor data is outputted to controller 104. Each resulting intensity of light sensed by light source sensor 80 can then be compared to the initial intensity by controller 104 to determine whether the associated laser delivery optical fiber is yet satisfactorily delivering laser light through it.

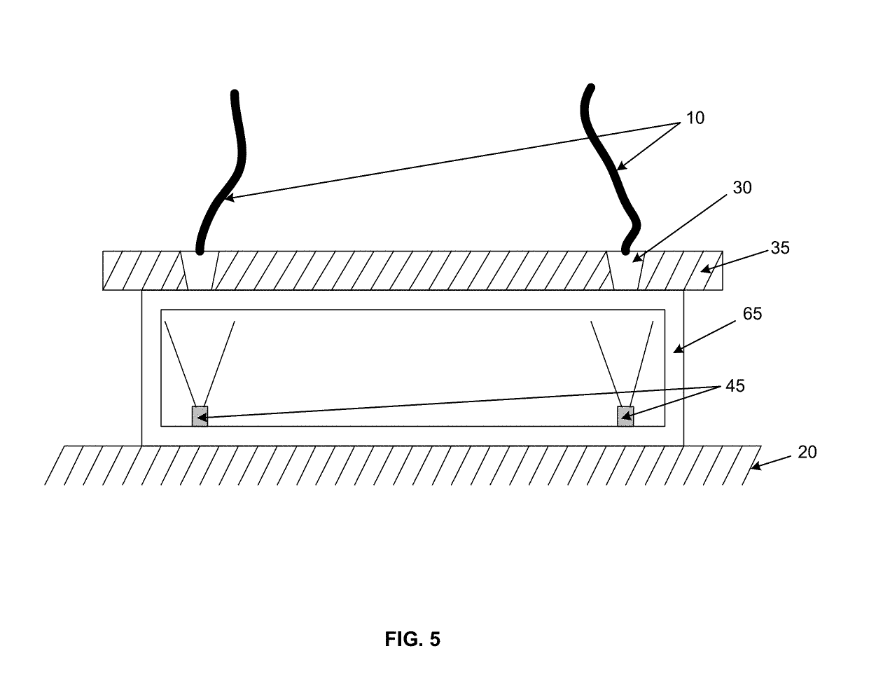

Referring to FIG. 5, an alternate embodiment is disclosed. Like in FIG. 1, this alternate embodiment includes a conventional method for simultaneous welding, wherein at least a laser delivery bundle 10 receives laser light from a laser bank 112 via source 122 of laser radiation. Each laser delivery bundle 10 may be further split into legs and each leg is comprised of at least a laser delivery optical fiber. If laser delivery bundle 10 is not split into legs, then each laser delivery bundle 10 is comprised of at least a laser delivery optical fiber. Each laser delivery optical fiber delivers laser light from laser bank 112 via source 122 of laser radiation through a waveguide 30 to a plurality of work pieces 60 to be welded together. Waveguide 30 homogenizes the laser light delivered to work pieces 60 through each laser delivery optical fiber. Between a number of weld cycles, a dummy part 65 is placed in the area where the plurality of work pieces 60 to be welded typically reside during a weld cycle. Dummy part 65 is luminescent. Dummy part 65 may be sized to approximately the same cumulative size of the plurality of work pieces 60. According to several embodiments, dummy part 65 is comprised of a light source 45 that is positioned to emit light through waveguide 30 and an associated laser delivery optical fiber to a sensor positioned within laser bank 112 to sense light emitted by light source 45 that has been directed from and subsequently traveled through a delivery end of the associated laser delivery optical fiber (such as sensor 70, as shown in FIG. 3). In this manner, the integrity of the associated laser delivery optical fiber may be determined. More specifically, the intensity of light emitted by dummy part 65 sensed by sensor 70 correlates to the integrity of the associated laser delivery optical fiber. For example, the intensity of light emitted by dummy part 65 having traveled through waveguide 30 and an associated laser delivery optical fiber sensed by sensor 70 before a single weld cycle has initiated is output to a controller 104. After each weld cycle (or after a number of weld cycles), dummy part 65 is placed in the area where the plurality of work pieces 60 to be welded typically resides during a weld cycle and emits light that passes through waveguide 30 and the associated laser delivery optical fiber at a downstream end to sensor 70. Sensor 70 senses the intensity of the emitted light and outputs the sensed intensity to controller 104. The resulting intensity of light sensed by sensor 70 can then be compared to the initial intensity by controller 104 to determine whether the associated laser delivery optical fiber is yet satisfactorily delivering laser light through it.

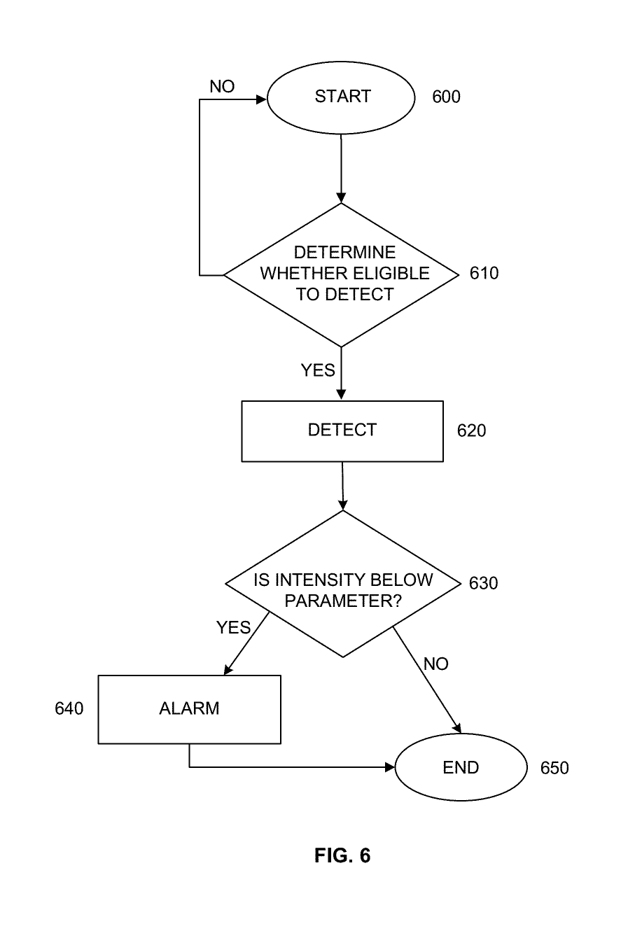

FIG. 6 is a flow chart of control logic for an example control routine implemented in controller 104 for determining whether a laser delivery bundle (such as laser delivery bundle 10) is delivering satisfactory laser light intensity. The control routine starts at 600 and proceeds to 610, where the controller determines whether determining whether a laser delivery bundle is delivering satisfactory laser light intensity is possible at that time. More specifically, if a laser bank (e.g., laser bank 112) has multiple sensors (such as light source 80 and laser bank sensor 90 with associated chromatic bandpass filters), then it is possible to determine whether a laser delivery bundle is delivering satisfactory laser light intensity. If, however, the laser bank has a single sensor (such as sensor 70), controller 104 first determines whether the laser emitted by laser bank 112 (e.g., via source 122 of laser radiation) has a wavelength the same as or similar to light emitted by a light source (such as light source 40). If not, determination may begin. But if the wavelengths of the laser emitted and the light source are the same or similar, then the determination may not begin to the extent a weld cycle is ongoing. Once any ongoing weld cycle finishes, the determination may then begin. And if a dummy part (e.g., dummy part 65) is used as the light source, controller 104 first determines the dummy part is in the position where the work pieces typically reside. After determining it is possible to determine whether a laser delivery bundle is delivering satisfactory laser light intensity, the control routine proceeds to 620, where a sensor (such as sensor 70 or light source sensor 80) detects light emitted from a light source. The control routine then proceeds to 630, where controller 104 determines whether the light intensity emitted by the light source sensed by the sensor is below a predetermined parameter. If controller 104 determines the sensed light intensity emitted by the light source is below a predetermined parameter, the control routine proceeds to 640, and controller 104 issues an alarm indicating same. After issuing the alarm or determining no alarm is required, the control routine proceeds to end 650.

In further embodiments, the fiber feedback system further includes a closed control loop, as described in U.S. Pat. No. 7,343,218, which is commonly owned by the same assignee and is incorporated herein by reference.

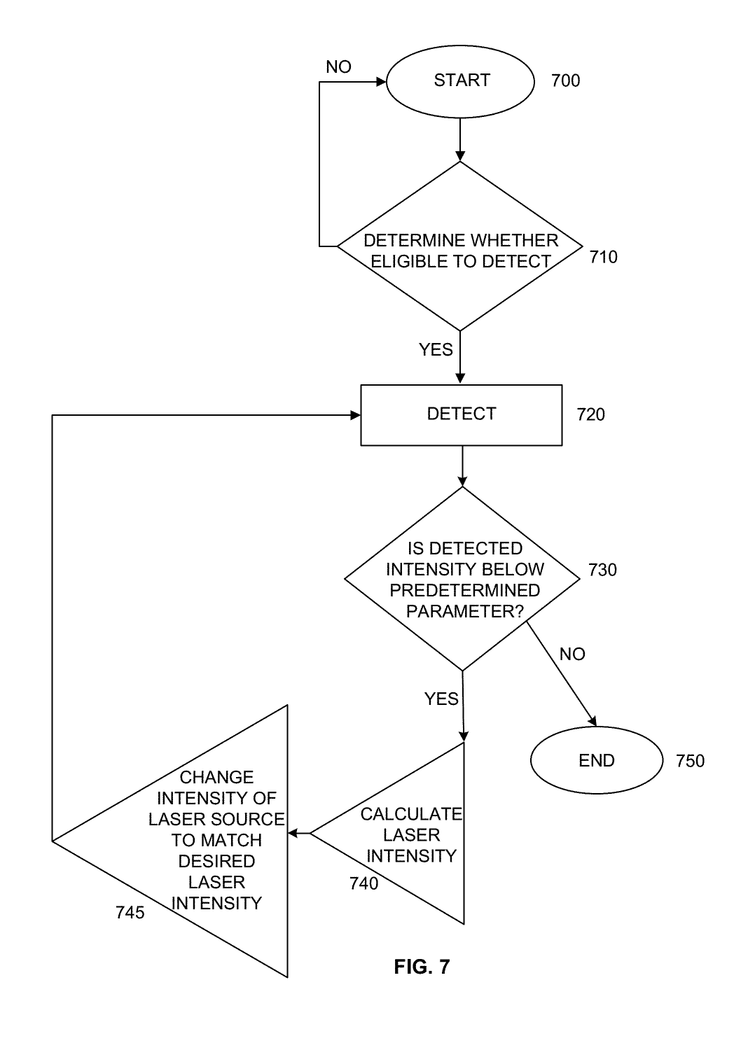

FIG. 7 is a flow chart of control logic for an example control routine implemented in controller 104 for determining whether a laser delivery bundle (such as laser delivery bundle 10) is delivering satisfactory laser light intensity. The control routine starts at 700 and proceeds to 710, where the controller determines whether determining whether a laser delivery bundle is delivering satisfactory laser light intensity is possible at that time. More specifically, if a laser bank (e.g., laser bank 112) has multiple sensors (such as light source 80 and laser bank sensor 90 with associated chromatic bandpass filters), then it is possible to determine whether a laser delivery bundle is delivering satisfactory laser light intensity. If, however, the laser bank has a single sensor (such as sensor 70), controller 104 first determines whether the laser emitted by laser bank 112 (e.g., via source 122 of laser radiation) has a wavelength the same as or similar to light emitted by a light source (such as light source 40). If not, determination may begin. But if the wavelengths of the laser emitted and the light source are the same or similar, then the determination may not begin to the extent a weld cycle is ongoing. Once any ongoing weld cycle finishes, the determination may then begin. And if a dummy part (e.g., dummy part 65) is used as the light source, controller 104 first determines the dummy part is in the position where the work pieces typically reside. After determining it is possible to determine whether a laser delivery bundle is delivering satisfactory laser light intensity, the control routine proceeds to 720, where a sensor (such as sensor 70 or light source sensor 80) detects light emitted from a light source. There is a direct correlation between the amount of light sensed by the sensor and the laser intensity of the laser emitted by laser bank 112 that is used in a weld cycle. The control routine proceeds to 730, where controller 104 assesses whether the detected intensity of the light emitted from a light source is below a predetermined parameter. If the detected intensity of the light emitted from a light source is not below a predetermined parameter, the assessment is ended and the control routine proceeds to 750. If, however, the detected intensity of the light emitted from a light source is sensed to be below a predetermined parameter, the controller then proceeds to calculate the laser intensity at 740, and controller 104 proportionally adjusts the intensity of the laser delivery bundle to bring the intensity within a predetermined range at 745. Further, if the light sensed occurs during a welding cycle, and controller 104 determines that the sensed light is below a predetermined range, controller 104 in some embodiments will rerun the weld cycle after having adjusted the intensity of the laser delivery bundle to bring the intensity within the predetermined range. After adjusting the intensity or determining no such adjustment is warranted, the control routine proceeds back to detecting laser intensity 720. If it is determined that the detected intensity of the light emitted from a light source is not below a predetermined parameter and the weld routine is therefore done in 730, control routine proceeds to end 750.

Controller 104 can be or includes any of a digital processor (DSP), microprocessor, microcontroller, or other programmable device which are programmed with software implementing the above described logic. It should be understood that alternatively it is or includes other logic devices, such as a Field Programmable Gate Array (FPGA), a complex programmable logic device (CPLD), or application specific integrated circuit (ASIC). When it is stated that controller 104 performs a function or is configured to perform a function, it should be understood that controller 104 is configured to do so with appropriate logic (such as in software, logic devices, or a combination thereof), such as control logic shown in the flow charts of FIGS. 6 and 7. When it is stated that controller 104 has logic for a function, it should be understood that such logic can include hardware, software, or a combination thereof.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for sensing the output of light travelling through a laser delivery optical fiber, the method comprising:
directing light emitted by a light source positioned downstream of a delivery end of the laser delivery optical fiber through said delivery end of said laser delivery optical fiber used in a simultaneous laser welding system comprised of a laser source that directs a laser from a laser bank from the input ends through to the delivery ends of a plurality of laser delivery bundles, wherein each laser delivery bundle is comprised of at least a laser delivery optical fiber for welding a plurality of work pieces; and
sensing the light after said light is directed from and has traveled through said delivery end to an input end of the associated laser delivery optical fiber with a sensor.

2. The method according to claim 1, wherein the directing the light is conducted by positioning the light source between the delivery end of the associated laser delivery optical end and the plurality of work pieces.

3. The method according to claim 2, further comprising covering the sensor with a chromatic bandpass filter.

4. The method according to claim 2, wherein emitting light via the light source occurs at a separate time interval from a weld cycle.

5. The method according to claim 1, wherein the directing the light is conducted by positioning the light source within a dummy part, wherein the dummy part is positioned where the plurality of work pieces typically reside during a weld cycle.

6. The method according to claim 1, further comprising outputting via the sensor the sensed light to a controller.

7. The method according to claim 6, further comprising determining via the controller whether the sensor sensed a satisfactory amount of light emitted by the light source and alerting a user via the controller when said sensor senses that said light emitted from said light source is unsatisfactory.

8. The method according to claim 6, further comprising welding via the simultaneous laser welding system the plurality of work pieces with laser light and adjusting said laser light intensity via the controller when the sensor senses that the light emitted from the light source is unsatisfactory.

9. A simultaneous laser welding apparatus, the simultaneous laser welding apparatus comprising:
a laser bank for outputting from a laser source laser light through a plurality of laser delivery bundles through a waveguide to a plurality of work pieces to be welded, wherein each said laser delivery bundle is comprised of at least a laser delivery optical fiber;
a light source positioned downstream of a delivery end of said laser delivery optical fiber, wherein said light source is positioned to direct light through the delivery end of said laser delivery optical fiber; and
a sensor positioned within said laser bank for sensing light directed from said light source through said laser delivery optical fiber, wherein said sensor relays the sensed light output to a controller.

10. The simultaneous laser welding apparatus according to claim 9, further comprising a chromatic bandpass filter covering the sensor.

11. The simultaneous laser welding apparatus according to claim 9, wherein the light source is positioned between the delivery end of the associated laser delivery optical fiber and the plurality of work pieces.

12. The simultaneous laser welding apparatus according to claim 11, wherein the light source is positioned within the waveguide.

13. The simultaneous laser welding apparatus according to claim 9, wherein the light source is positioned within a dummy part and the dummy part is positioned where the plurality of work pieces typically reside during a weld cycle.

14. The simultaneous laser welding apparatus according to claim 9, wherein the controller is configured to determine whether the sensor sensed a satisfactory amount of light emitted by the light source and alert a user when said sensor senses that said light emitted from said light source is unsatisfactory.

15. The simultaneous laser welding apparatus according to claim 9, wherein the controller is configured to adjust the laser light intensity when the sensor senses that the light emitted by the light source is unsatisfactory.
